(19) United States
(12) Patent Application Publication
(10) Pub. No.: US 2012/0035339 A1
(43) Pub. Date: Feb. 9, 2012

(54) ETHYLENE COPOLYMER

(75) Inventors: Godefridus Arnoldus Henricus Nooijen, Geleen (NL); Matthijs van Kessel, van Kessel (NL)

(73) Assignee: SAUDI BASIC INDUSTRIES CORPORATION, Riyadh (SA)

(21) Appl. No.: 13/263,795

(22) PCT Filed: Apr. 6, 2010
(86) PCT No.: PCT/EP2010/002175

§ 371 Date: Oct. 10, 2011

(30) Foreign Application Priority Data
Apr. 10, 2009 (EP) 09075175.1

(51) Int. Cl. C08F 210/16; B29C 49/04; C08F 4/69

(52) U.S. Cl. 526/125.3; 526/132; 526/134; 264/540

(57) ABSTRACT

The invention is directed to a slurry phase polymerisation process for the preparation of ethylene-α-olefin copolymers by polymerising ethylene in the presence of a chromium containing catalyst and a diluent. The polymerisation takes place in the presence of·a chromium-containing catalyst, ·an aliphatic or alicyclic boron compound having at least one boron to carbon linkage and·an aliphatic or alicyclic group MA or group IMA element based compound having at least one metal or metalloid to carbon linkage wherein the chromium containing catalyst is not reduced by carbon monoxide after the activation in a non-reducting atmosphere and wherein the metal or metalloid is present in an amount higher than 1 ppm relative to the amount of diluent.

### CROSS REFERENCE TO RELATED APPLICATIONS

This application is a 371 of International Application No. PCT/EP2010/002175, filed Apr. 6, 2010, which claims priority to European Application No. 09075175.1, filed Apr. 10, 2009, both of which are hereby incorporated by reference in its entirety.

### TECHNICAL FIELD

The invention relates to a slurry phase polymerisation process for the preparation of ethylene-α-olefin copolymers by polymerising ethylene in the presence of a chromium containing catalyst and a diluent.

### BACKGROUND

EP1172381 A1 discloses the polymerization of ethylene in co-presence of hydrogen and a catalyst containing a premixed mixture of trialkylaluminium and chromium. The chromium catalyst is obtained by calcination-activating a chromium compound that is carried on an inorganic oxide carrier in a non-reducing atmosphere to convert chromium atoms in the chromium compound into hexavalent chromium atoms for at least a portion thereof, and treating with a trialkylaluminum compound in an inert hydrocarbon solvent to carry thereon and removing to dry the solvent so that the chromium atoms are not over-reduced by the trialkylaluminum compound. When the polymerization of ethylene is performed using this chromium catalyst, α-olefin is by-produced from ethylene and α-olefin is further co-polymerized with ethylene. Therefore, use of ethylene as the monomer results in the production of a copolymer of ethylene and α-olefin. The type of α-olefin by-produced includes 1-butene, 1-hexene and 1-octene and is in particular 1-hexene.

It is a disadvantage of the process according to EP1172381 A1 that the chromium catalyst and the trialkylaluminum compound have to be premixed. The amount of α-olefin production depends on the trialkylaluminium/catalyst ratio used in catalyst preparation and on the amount of catalyst in the polymerization reactor. The density of the produced polymer product is fixed and must be controlled by additional dosing of α-olefin because the amount of α-olefin production depends on the trialkylaluminium/catalyst ratio in the trialkylaluminium compound carried chromium catalyst.

It is another disadvantage of the process according to EP-A-1172381 that the amount of α-olefin produced depends on the amount of catalyst present in the polymerization reactor. In a commercial polymer production plant the catalyst activity varies and the amount of catalyst has to be adapted to keep production of the amount of polymer in the reactor at a constant level. The varying amount of catalyst will result in a varying amount of by-produced α-olefin. In the case that the amount of α-olefin is too high no desired product will be produced and in the case that the amount of α-olefin is too low additional α-olefin dosing is necessary to keep the density constant. Consequently the process according to EP1172381 does not result in ethylene-α-olefin copolymers from ethylene with the desired consistency on a commercial scale.

A further disadvantage of the process according to EP1172381 A1 is the need to execute a reaction between the calcined, hexavalent chromium containing catalyst and the trialkylaluminium under slurry conditions and subsequent drying. The necessary hardware to produce this catalyst on a commercial scale makes the catalyst much more expensive. Furthermore the handling of hexavalent chromium compound is a considerable health risk as these compounds are carcinogenic.

### SUMMARY

It is the object of the present invention to provide a process that results in ethylene-α-olefin copolymers having the desired properties for example environmental stress crack resistance (ESCR) by polymerising ethylene without the addition of α-olefin monomer.

### DETAILED DESCRIPTION

The invention is characterised in that the ethylene-α-olefin copolymer is obtained by polymerizing ethylene in the presence of
a chromium-containing catalyst,
an aliphatic or alicyclic boron compound having at least one boron to carbon linkage and
an aliphatic or alicyclic group IIA or group MA element based compound having at least one metal or metalloid to carbon linkage
   wherein the chromium containing catalyst is not reduced by carbon monoxide after the activation in a non-reducing atmosphere and wherein the metal or metalloid is present in an amount higher than 1 ppm relative to the amount of diluent.

The process according to the present invention results in the in-situ production of α-olefins. The α-olefins may be primarily 1-hexene and there may be produced also a smaller amount of 1-butene and/or 1-octene from ethylene. The produced α-olefins are copolymerised with ethylene producing polyethylene with excellent properties such as for example very good ESCR. The copolymers also may include for example terpolymers of ethylene, 1-hexene and 1-butene.

The process according to the present invention also results in much higher catalyst activities compared to production of similar polyethylene without in situ α-olefin production. The α-olefin production in the process according to the present invention can be controlled independently with the amount of group IIA or group IIIA element based compound.

Suitable aliphatic or alicyclic boron compounds include for example triethyl borane, tri-n-butyl borane, triisobutyl borane, tri-n-propyl borane, tri-n-octyl borane,trimethyl borane, tri-sec-butyl borane, tri-isopropyl borane, trihexyl borane, tripentyl borane, triphenyl borane, tribenzyl borane, tridecyl borane tridodecyl borane, diethyl boron ethoxide and/or diethyl boron methoxide.

Preferably the aliphatic or alicyclic boron compound having at least one boron to carbon linkage is a (C₁-C₁₂) alkyl boron compound. More preferably the alkyl-containing boron compound is a (C₁- C₁₀) alkyl-containing boron compound.

More preferably, the alkyl-containing boron compound is triethyl borane (TEB).

Generally the boron concentration in the polymerization reactor is less than 5.0 ppm of boron based on the diluent.

Preferably, the concentration is less than 1.0 ppm of boron and more preferably the concentration is less than 0.5 ppm boron and even more preferably the concentration is less than 0.25 ppm boron.

Preferably, the metal or metalloid in the aliphatic or alicyclic group IIA or group IIIA from the Periodic Table of the Elements according to Mendeleev based compound is aluminium (metal), magnesium (metal) or boron (metalloid).

Preferably the metal or metalloid is present in an amount between 1 ppm and 50 ppm relative to the amount of diluent.

More preferably the metal or metalloid is present in an amount between 1 ppm and 20 ppm relative to the amount of diluent.

According to a further preferred embodiment of the invention the metal or metalloid is present in an amount between 1 ppm and 10 ppm relative to the amount of diluent.

According to another preferred embodiment of the invention the metal or metalloid is present in an amount higher than 2 ppm relative to the amount of diluent.

More preferably the metal or metalloid is present in an amount higher than 3 ppm relative to the amount of diluent.

The selection of the amount of the metal or metalloid present is important because the process according to the invention does not result in the desired products in the case that an amount lower than 1 ppm is applied and no comonomer is used during the polymerisation process.

According to a preferred embodiment of the invention the aliphatic or alicyclic group IIA or group IIIA element based compound having at least one metal or metalloid to carbon linkage is a group IIA or group IIIA element based (C₁-C₁₂) alkyl compound.

Suitable examples of these group IIA or group IIIA element based compounds include trimethyl aluminium, triethyl aluminium, triisobutyl aluminium, tri-n-butyl aluminium, tri-n-hexyl aluminium, trioctyl aluminium, diisobutylaluminium hydride, diethylaluminiumethoxide, diethylaluminium hydride, diisobutylaluminiumethoxide, isoprenylaluminium, ethylbutylmagnesium, di-n-butylmagnesium, di-n-hexylmagnesium, triethylborane, tri-n-butyl borane, triisobutylborane, tri-n-propylborane, tri-n-octylborane, trimethylborane, tri-sec-butylborane, tri-isopropylborane, trihexylborane, tripentylborane, triphenylborane, tribenzylborane, tridecyl borane tridodecylborane, diethyl boron ethoxide and/or diethyl boron methoxide.

According to a further preferred embodiment of the invention the metal is aluminium.

It is an advantage of the present invention that premixing of the chromium-containing catalyst and the group IIA or group IIIA element based compound is not necessary because the α-olefins are also generated in situ when the chromium-containing catalyst and the metal or metalloid compound are added to the reactor separately

It is another advantage of the process according to the present invention that a copolymer is obtained from only ethylene as monomer at a very high catalyst activity by adding the chromium containing catalyst, the group IIA or group MA element based compound and the boron compound to the ethylene monomer in the reactor.

It is a further advantage of the process according to the invention that the amount of in situ produced α-olefins can easily be controlled with the alkyl containing metal or metalloid compound.

The in situ produced α-olefin may be 1-butene, 1-hexene and 1-octene. In general 1-hexene is the main produced α-olefin.

Hydrogen can be used in the polymerization process of the present invention for example to control melt flow index, die swell as well as elasticity of the polymer products.

The α-olefin production depends on the concentration of group IIA or group MA element based compound and this concentration can thus be used to control the density of the polymer. In the case that a further decrease in density is requested and in the case that this decrease cannot be realized by adding more of the group IIA or group MA element based compound because of a possible unwanted side effect, it is possible to dose additional α-olefin to the reactor.

According to a preferred embodiment of the invention the ethylene-α-olefin copolymer is obtained by polymerizing ethylene in the presence of a chromium-containing catalyst, a (C₁-C₁₂) alkyl boron compound and a group IIA or group MA element based (C₁-C₁₂) alkyl compound.

The polymerization is performed via a slurry phase polymerisation process. This process is disclosed for example in Handbook of Polyethylenes by Andrew Peacock, 2000, pages 57-64.

Preferably, the polymerization of ethylene takes place in a diluent at a temperature of between 90° C. and 110° C.

Suitable diluents include paraffins, cycloparaffins and/or aromatic hydrocarbons such as for example isobutane and propane.

Generally the chromium-containing catalyst contains a support.

Preferably the support is a silica support. The silica may have a surface area (SA) larger than 200 m²/g and a pore volume (PV) larger than 0.8 cm³/g.

The support may be modified so as to include cogels such as for example silic-titania or silica-alumina and by the replacement of silica by alumina or amorphous aluminium phosphates. Furthermore, the support may comprise a tergel which is produced for example by mixing a chromium source with the silica and titania compound. The chromium-containing catalyst may also be doped with chemical compounds containing for example aluminium, titanium, phosphorus, boron or fluor for example by impregnation of the porous chromium-containing supports with a solution of any one of these compounds.

The amount of chromium in the catalyst is generally at least 0.5% by weight.

Preferably the amount of chromium in the catalyst is at least 1.0 wt %.

According to a preferred embodiment of the invention the average particle size (D₅₀) of the catalyst is between 25 and 150 micrometers. Generally, the catalyst is activated before being applied in the polymerization reaction. The activation may take place under different conditions. The activation generally takes place at an elevated temperature, for example, at a temperature above 450° C. The activation may take place in different atmospheres, for example in dry air. In the process according to the present invention the chromium containing catalyst is not reduced by carbon monoxide after the activation in a non-reducing atmosphere for example air.

According to a preferred embodiment the activation takes place at least partially under an inert atmosphere. Preferably the inert atmosphere is a nitrogen atmosphere. At the same time the temperature is raised slowly. It has been found to be advantageous to change from the nitrogen atmosphere to an atmosphere of dry air at a temperature of at most 700° C. The activation time after reaching the maximum temperature may last for several minutes to several hours. Preferably this activation time is at least 1 hour but it may be advantageous to activate during a longer period.

The specific surface area (SA) is in m²/gram and is determined using the so-called BET method and wherein the pore volume (PV) is in cm ³/gram and is determined by nitrogen capillary condensation. (Recommendations IUPAC 1991; Pure and App. Chem., Vol. 63, 9, 1227-1246)

The properties of the catalyst, pore volume and specific surface area are determined before the catalyst is activated at an elevated temperature.

The ethylene copolymer obtained with the process according to the present invention is a HDPE having:
a high-load melt index (HLMI) ≧1 g/10 min and ≦100 g/10 min (according to ISO 1133) and
a density ≧940 kg/m³ and ≦965 kg/m³ (according to ISO1183),

Said testing methods are described in the Examples.

The ethylene copolymers obtained with the process according to the invention may be combined with additives such as for example lubricants, fillers, stabilizers, antioxidants, compatibilizers and pigments. The additives used to stabilize the copolymers may be, for example, additive packages including hindered phenols, phosphites, UV stabilsers, antistatics and stearates.

An anti static agent can be used to suppress fouling of the reactor wall. Examples of suitable anti static agents are disclosed in U.S. Pat. No. 4,182,810, EP107127 A1 or Research Disclosure 515018.

The ethylene copolymers may be extruded or blow-moulded into articles such as for example bottles, containers, fuel tanks and drums, or may be extruded or blown into films.

EP307907 A1 discloses a process to produce polyolefins which uses hydrogen to control the resultant polymer characteristics. Polymer density, in-situ comonomer production, and polymer short chain branching can be regulated by the use of a carbon monoxide reduced polymerization catalyst system. The process according to EP307907 A1 is characterized by subjecting to polymerization ethylene in the presence of a catalyst composition comprising (a) a catalyst having a chromium component on a high titania silica-titania cogel support, obtained by heat-activation in an oxygen-containing ambient to convert at least a portion of any chromium in a lower valent state to the hexavalent state, followed by treatment with carbon monoxide under reducing conditions, and (b) a cocatalyst selected from trialkyl boron compounds, dialkyl aluminum alkoxide compounds, trialkyl aluminum compounds, and mixtures thereof, wherein said (a) and (b) are premixed in an inert ambient prior to contacting said ethylene; and by introducing hydrogen during said polymerization in such an amount to control the density of the produced copolymer within the aforesaid range. It is a disadvantage of the process according to EP307907 A1 that the chromium containing catalyst has to be reduced with CO at a high temperature. Another disadvantage is that the reduced catalyst has to be pre-mixed with the trialkyl boron and/or trialkylaluminium compound. The required additional hardware to produce this catalyst on commercial scale makes the catalyst much more expensive. Furthermore the handling of CO in a commercial production process is a considerable health risk. A further disadvantage of this process is that because of the necessary pre-mixing of the reduced chromium containing catalyst and the trialkyl boron and/or trialkylaluminium compound the ratio is fixed and therefore the polymer properties are also fixed except for density which can apparently be controlled with hydrogen.

WO 01/34661 discloses a polymerisation process in the presence of an ethylene monomer, at least one comonomer and a catalyst system comprising chromium on a silica-titania support. An essential diiference between the process according to the present invention and the process according to the invention is the presence of the comonomer in WO 01/34661 whereas the process according to the present invention takes place without the addition of an α-olefin monomer. Another essential difference is the amount of applied metal. In the present invention the metal or metalloid is present in an amount higher than 1 ppm relative to the amount of diluent whereas regarding the examples 43-47 of WO 01/34661 this amount ranges between 0.07 and 0.55 ppm. To obtain suitable products with the process according to WO 01/34661 a comonomer has to be used during the polymerisation process.

The invention will be elucidated by means of the following non-limiting examples.

### EXAMPLES

The characteristics of polyethylene obtained in the examples were determined as follows:
The high-load melt index (HLMI) of polyethylene was measured according to ISO 1133 on pellets at 190° C. with a test weight of 21.6 kg.
The density of polyethylene was measured according to ISO 1183 (with additional annealing step) (30 minutes boiling and cooling in water).
The strain hardening modulus is a measure of environmental stress crack resistance of high density polyethylene. The strain hardening modulus of polyethylene was measured by the method as described by Kurelec et al. in Elsevier, Polymer 46(2005) 6369-6379.
The impact properties were measured at −30° C. according to Izod (ISO 180 type A) on bars, cutted out of pressed plates

### Example I

Ethylene was polymerized in a continuously operated 5 L liquid-filled CSTR reactor in isobutane at 46 bar (46.10⁵ MPa) in the presence of a silica supported chromium catalyst which has been activated at 650° C. in dry air and triethylboron (TEB) and triisobutylaluminium (TIBA). The silica supported chromium catalyst had a pore volume of 2.62 ml/g, a surface area of 604 m²/g, an average particle size of 67 micrometers and contained 1.08 wt % chromium.

Isobutane (2, 82 kg/h), ethylene (1.27 kg/h), and hydrogen (1.0 g/h) were continuously fed to the reactor at 99.5° C. TEB (1.2 ppm relative to amount of isobutane) and TIBA(22 ppm relative to amount of isobutane) were also continuously fed to the reactor in such amounts that the concentration of boron in the isobutane was 0.12 ppm relative to the amount of isobutane and the concentration of aluminium in the isobutane was 3.0 ppm relative to the amount of isobutane.

The catalyst feed to the reactor was controlled in order to maintain a constant ethylene concentration in the reactor of 10.2 mol %.

Polyethylene production was 1.05 kg/h.

The catalyst activity was 5500 g of polyethylene per g of catalyst. The concentration of 1-hexene in the diluent was 0.3 mol % (analysed via gas chromatography).

After stabilization, the polymer powder was pelletized in a twin screw extruder.

The polyethylene pellets had the following characteristics:
density: 951.2 kg/m³
strain hardening modulus: 27.1 MPa
high-load melt index: 6.1 g/10 min
impact Izod (−30° C.): 20.7 KJ/m2
die swell 800 s⁻¹: 2.5

### Comparative Example A

Ethylene was polymerised according to Example I except that no triisobutylaluminium was used and that 1-hexene was added to the polymerization reactor.

Isobutane (2.83 kg/h), ethylene (1.27 kg/h), 1-hexene (32 g/h) and hydrogen (0.38 g/h) were continuously fed to the reactor at 99.5° C.

TEB (1.2 ppm relative to the amount of isobutene) was also continuously fed to the reactor in such an amount that concentration of boron in the isobutane was 0.12 ppm.

The catalyst feed to the reactor was controlled in order to maintain a constant ethylene concentration in the reactor of 9.2 mol %.

Polyethylene production was 1.07 kg/h.

The catalyst activity was 3500 g of polyethylene per g of catalyst.

After stabilization, the polymer powder was pelletized in a twin screw extruder.

The polyethylene pellets had the following characteristics:
density: 950.8 kg/m³
strain hardening modulus: 28.0 MPa
high-load melt index: 6.8 g/10 min
Impact Izod (−30° C.): 18.7 KJ/m²
die swell 800 s⁻¹ 2.9

Example I shows that a copolymer with excellent properties is produced from ethylene at very high catalyst yield with a chromium containing catalyst system activated with TEB by adding TIBA to the reactor.

1. A slurry phase polymerisation process for the preparation of ethylene-α-olefin copolymers by polymerising ethylene in the presence of a chromium containing catalyst and diluent characterised in that the polymerisation takes place in the presence of
a chromium-containing catalyst,
an aliphatic or alicyclic boron compound having at least one boron to carbon linkage and
an aliphatic or alicyclic group IIA or group IIIA element based compound having at least one metal or metalloid to carbon linkage
wherein the chromium containing catalyst is not reduced by carbon monoxide after the activation in a non-reducing atmosphere and wherein the metal or metalloid is present in an amount higher than 1 ppm relative to the amount of diluent.

2. The process according to claim 1, wherein the metal or metalloid is present in an amount between 1 ppm and 50 ppm relative to the amount of diluent.

3. The process according to claim 1, wherein the aliphatic or alicyclic boron compound having at least one boron to carbon linkage is (C₁-C₁₂) alkyl boron compound.

4. The process according to claim 1, wherein the boron compound is triethyl borane, tri-n-butyl borane, triisobutyl borane, tri-n-propyl borane, tri-n-octyl borane, trimethyl borane, tri-sec-butyl borane, tri-isopropyl borane, trihexyl borane, tripentyl borane, triphenyl borane, tribenzyl borane, tridecyl borane tridodecyl borane, diethyl boron ethoxide and/or diethyl boron methoxide.

5. The process according to claim 1, wherein the boron compound is triethyl borane.

6. The process according to claim 1, wherein the aliphatic or alicyclic group IIA or group IIIA element based compound having at least one metal or metalloid to carbon linkage is a group IIA or group IIIA element based (C₁-C₁₂) alkyl compound.

7. The process to claim 6, wherein the metal or metalloid is aluminium, magnesium or boron.

8. The process according to claim 6, wherein the aliphatic or alicyclic group IIA or group IIIA element based compound having at least one metal or metalloid to carbon linkage is trimethyl aluminium, triethyl aluminium, triisobutyl aluminium, tri-n-butyl aluminium, tri-n-hexyl aluminium, trioctyl aluminium, diisobutylaluminium hydride, diethylaluminiumethoxide, diethylaluminium hydride, diisobutylaluminiumethoxide, isoprenylaluminium, ethylbutylmagnesium, di-n-butylmagnesium, di-n-hexylmagnesium, triethylborane, tri-n-butyl borane, triisobutylborane, tri-n-propylborane, tri-n-octylborane, trimethylborane, tri-sec-butylborane, tri-isopropylborane, trihexylborane, tripentyl borane, triphenyl borane, tribenzylborane, tridecylborane tridodecylborane, diethyl boron ethoxide and/or diethyl boron methoxide.

9. The process according to claim 6, that the compound is an aluminium (C₁-C₁₂) alkyl compound.

10. The process according to claim 9 9, wherein the aluminium (C₁-C₁₂) alkyl compound is triisobutyl aluminium.

11. High density polyethylene having a high load melt index ≧1 g/10 min and ≦100 g/10 min (according to ISO 1133) and a density ≧940 kg/m³ and ≦965 kg/m³ (according to ISO1183) obtained with the process according to claim 1.

12. Use of an ethylene-α-olefin copolymer obtained with the process according to claim 1.

13. Use of the polyethylene according to claim 11, in the production of extruded or blow moulded articles.
